(19) United States
(12) Patent Application Publication
(10) Pub. No.: US 2022/0322872 A1
(43) Pub. Date: Oct. 13, 2022

(54) COOKING IMPLEMENT

(71) Applicant: Ernest William Taylor, Prince George (CA)

(72) Inventor: Ernest William Taylor, Prince George (CA)

(21) Appl. No.: 17/226,210

(22) Filed: Apr. 9, 2021

(51) Int. Cl. A47J 37/04; A47J 37/07

(52) U.S. Cl. CPC A47J 37/049; A47J 37/0786

(57) ABSTRACT

A cooking implement configured to assist in the cooking process of a hot dog or similar item wherein the present invention facilitates the rotational movement of the food item during the cooking process. The present invention includes a support frame wherein the support frame is comprised of a bottom horizontal member and a vertical support member. The vertical support member includes a plurality of contiguous segments formed in a human outline shape. The frame has a food rod tube coupler secured thereto. A food rod tube is secured to the food rod tube coupler and has a hollow passage therethrough. The food rod tube further includes an engagement tab at an end distal to the support frame. A plurality of food rod support members are provided that operably couple with the food rod tube having a portion egressing therefrom.

### FIELD OF THE INVENTION

The present invention relates generally to cooking accessories, more specifically but not by way of limitation, a cooking implement that is configured to assist in the cooking process of food such as but not limited to hot dogs and sausage, wherein the present invention includes a support frame, a mounting tube and a plurality of food support rod members.

### BACKGROUND

As is known in the art, there are numerous cooking techniques that have been utilized for decades. One of the most basic cooking techniques that has been utilized for centuries is cooking with open fire or coals. This cooking technique is employed to cook everything from meats, fish and vegetables. One type of meat that is popular to cook on a grill or over an open fire are hot dogs and sausages. As is known in the art, these types of meat products are generally cylindrical in shape having an exterior casing that is filled with a blend of ground meats.

One challenge with cooking the aforementioned types of meat is achieving an even cooking of the exterior as well as control of the product during the cooking process. Due to the shape of the product it can be difficult to maintain exposure to the heat source consistently around the circumference of the hot dog or sausage. The aforementioned challenges often result in an undesirable cooking of meats such as but not limited to hot dogs or sausages.

It is intended within the scope of the present invention to provide a cooking implement that is configured to assist in the process of cooking hot dogs and sausages wherein the present invention provides the ability to rotatably control the food during the process.

### SUMMARY OF THE INVENTION

It is the object of the present invention to provide a cooking implement configured to assist in the cooking of meats such as but not limited to hot dogs or sausages so as to provide even cooking thereof wherein the present invention includes a support frame.

Another object of the present invention is to provide a cooking accessory operable to assist in the cooking of hot dogs or the like over a fire or grill wherein the support frame of the present invention includes a bottom horizontal support member.

A further object of the present invention is to provide a cooking implement configured to assist in the cooking of meats such as but not limited to hot dogs or sausages so as to provide even cooking thereof wherein the support frame further includes a vertical support member extending upward from the bottom horizontal support member.

Still another object of the present invention is to provide a cooking accessory operable to assist in the cooking of hot dogs or the like over a fire or grill wherein the support frame further includes a food rod tube coupler secured thereto.

An additional object of the present invention is to provide a cooking implement configured to assist in the cooking of meats such as but not limited to hot dogs or sausages so as to provide even cooking thereof wherein the present invention further includes a food rod tube that is operably coupled to the food rod tube coupler on the support frame.

Yet a further object of the present invention is to provide a cooking accessory operable to assist in the cooking of hot dogs or the like over a fire or grill wherein the present invention further includes a plurality of food rod support members.

Another object of the present invention is to provide a cooking implement configured to assist in the cooking of meats such as but not limited to hot dogs or sausages so as to provide even cooking thereof wherein the food rod support members are insertable into the food rod tube and rotatably movable therein.

An alternate object of the present invention is to provide a cooking accessory operable to assist in the cooking of hot dogs or the like over a fire or grill wherein the food rod tubes include an engagement tab formed on one end thereof.

Still a further object of the present invention is to provide a cooking implement configured to assist in the cooking of meats such as but not limited to hot dogs or sausages so as to provide even cooking thereof wherein the present invention is manufactured from metal.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a view of the support frame, food rod tube and food rod support members; and

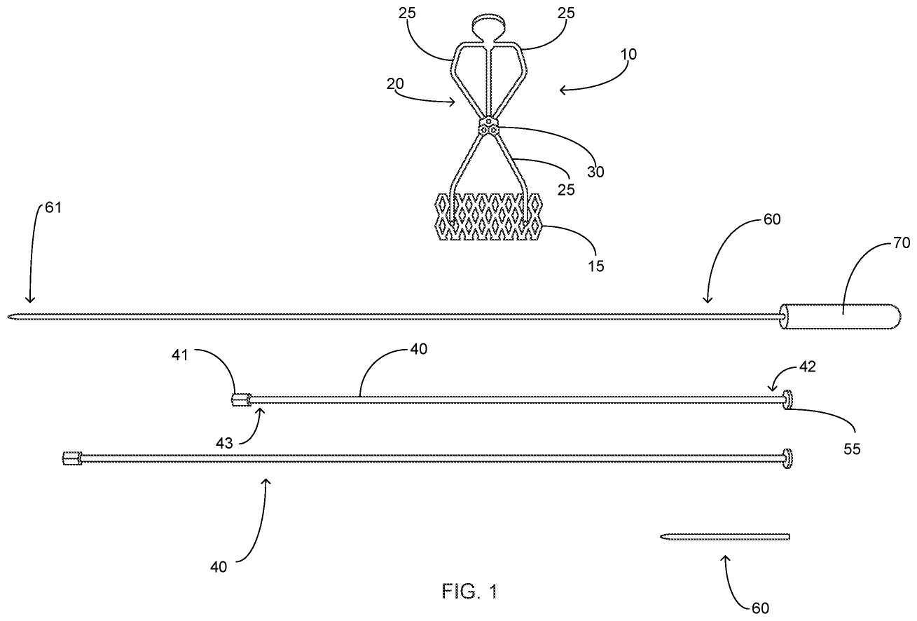

FIG. 2 is a perspective view of the present invention in an assembled state.

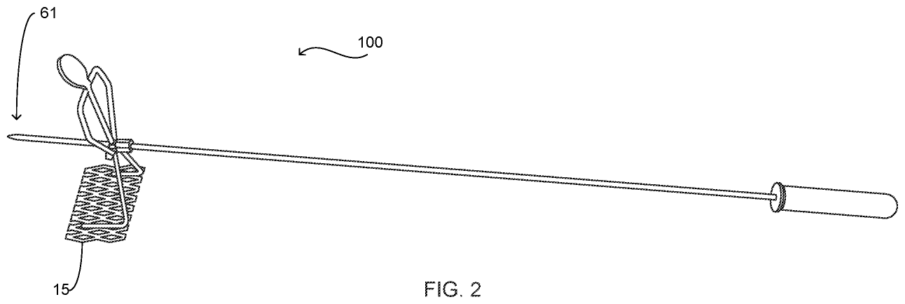

### DETAILED DESCRIPTION

Referring now to the drawings submitted herewith, wherein various elements depicted therein are not necessarily drawn to scale and wherein through the views and figures like elements are referenced with identical reference numerals, there is illustrated a cooking implement 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Now referring to the drawings submitted herewith, the cooking implement 100 further includes a support frame 10. The support frame 10 is manufactured from a suitable durable material such as but not limited to metal. The support frame 10 includes a bottom horizontal member 15 wherein the bottom horizontal support member 15 is planar in manner. The bottom horizontal support member 15 is operable to be superposed a support surface such as but not limited to a grill or an area adjacent to a grill. While the bottom horizontal support member 15 is illustrated as being rectangular herein, it should be understood within the scope of the present invention that the bottom horizontal support member 15 could be formed in alternate shapes and sizes.

The vertical support member 20 is secured to the bottom horizontal support member 15 extending upward therefrom and being generally perpendicular therewith. The vertical support member 20 is manufactured from metal and is secured to the bottom horizontal support member 15 utilizing suitable techniques such as but not limited to welding. The vertical support member 20 is comprised of a plurality of contiguous segments 25 wherein the segments 25 are integrally formed utilizing a suitable technique. The segments 25 are manufactured from metal and are formed so as to resemble an outline shape of a human body. While the segments 25 are formed to resemble a human figure outline in the preferred embodiment of the present invention, it should be understood within the scope of the present invention that the segments 25 could be formed to create alternate shapes and/or symbols.

The vertical support member 20 further includes a food rod tube coupler 30 secured thereto proximate the middle region thereof. The food rod tube coupler 30 is configured to mateably couple with the fastener 41 formed on the end of the food rod rube 40. The food rod tube coupler 30 extends rearward from the vertical support member 20 and in a preferred embodiment includes a threaded outer surface so as to facilitate mechanical coupling with the fastener 41. It should be understood within the scope of the present invention that the food rod tube coupler 30 could be formed in alternate manners in order to achieve the desired objective of providing a technique to mechanically couple to the fastener 41 of the food rod tube 40.

The food rod tube 40 is a hollow metal tube having a first end 42 and second end 43. The food rod tube 40 as illustrated herein is provided in alternate lengths so as to accommodate various lengths of food rod support members 60. Food rod tube 40 has an internal diameter being sufficient to allow the food rod support member 60 to be movable therein so as to allow rotational movement and a backward-forwards movement. Secured to the first end 42 of the food rod tube 40 is engagement tab 55. Engagement tab 55 is formed from metal or other suitable material and is secured to the exterior of the food rod tube 40 utilizing suitable techniques. The engagement tab 55 is perpendicular to the food rod tube 40 and is circumferentially present thereto. While the engagement tab 55 is illustrated herein as being annular in shape, it should be understood that the engagement tab 55 could be formed in alternate shapes and sizes. The engagement tab 55 provides a surface for a user having a hand coupled to the handle 70 to bias against with a thumb so as to remove a food item from end 61 of the food rod support member 60.

The food rod support member 60 is a metal rod being provided in alternate lengths. The food rod support member 60 includes a first end 61 having a tapered point so as to facilitate journaling into a food item such as but not limited to a hot dog. Secured to the second end 62 of the food rod support member 60 is a handle 70. The handle 70 can be provided in alternate embodiments as illustrated herein and functions to provide an element for a user to grasp the food rod support member 60.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding description is, therefore, not intended to be limited to the specific forms set forth herein, but on the contrary, it is intended to cover such alternatives, modifications, and equivalents, as can be reasonably included within the spirit and scope of the invention.

What is claimed is:

1. A cooking implement that is configured to assist in a cooking process of a food item wherein the cooking implement comprises:
a support frame, said support frame being manufactured from a heat resistant rigid material, said support frame having a bottom horizontal member, said support frame having a vertical support member, said vertical support member secured to said bottom horizontal support member and extending upward therefrom;
a food rod tube, said food rod tube being tubular and hollow, said food rod tube having a first end and a second end, said first end of said food rod tube being secured to said support frame; and
at least one food rod support member, said at least one food rod support member configured to be journaled into said food rod tube, said at least one food rod support member having a portion extending past said support frame on an opposing side from the food rod tube.

2. The cooking implement as recited in claim 1, wherein said at least one food rod support member has a first end and a second end, said second end being tapered in shape.

3. The cooking implement as recited in claim 2, and further including a food rod tube coupler, said food rod tube coupler being secured to said support frame, said food rod tube coupler configured to have said food rod tube secured thereto.

4. The cooking implement as recited in claim 3, wherein said vertical support member is comprised of a plurality of contiguous segments.

5. The cooking implement as recited in claim 4, wherein said vertical support member is formed in a shape of a human body outline.

6. The cooking implement as recited in claim 5, wherein said food rod tube further includes an engagement tab, said engagement tab being formed on said second end of said food rod tube.

7. A cooking implement that is configured to assist in a cooking process of a hot dog or similar food item being placed adjacent a cooking source wherein the cooking implement comprises:
a support frame, said support frame being manufactured from a heat resistant rigid material, said support frame having a bottom horizontal member, said bottom horizontal member being planar in manner and rectangular in shape, said support frame having a vertical support member, said vertical support member secured to said bottom horizontal support member and extending upward therefrom, said vertical support member being perpendicular to said bottom horizontal member;
a food rod tube, said food rod tube being tubular and hollow, said food rod tube having a first end and a second end, said first end of said food rod tube being secured to a food rod tube coupler, said food rod tube coupler being secured to said vertical support member of said support frame; and
at least one food rod support member, said at least one food rod support member configured to be journaled into said food rod tube, said at least one food rod support member having a portion extending past said support frame on an opposing side from the food rod tube.

8. The cooking implement that is configured to assist in a cooking process of a hot dog as recited in claim 7, wherein said food rod tube further includes an engagement tab, said engagement tab being annular in shape, said engagement tab being formed on said second end of said food rod tube.

9. The cooking implement that is configured to assist in a cooking process of a hot dog as recited in claim 8, wherein said vertical support member is comprised of a plurality of contiguous segments, said vertical support member being formed in a shape of a human body outline.

10. The cooking implement that is configured to assist in a cooking process of a hot dog as recited in claim 9, wherein said at least one food rod support member includes a portion thereof that extends beyond said support frame ensuing insertion into the food rod tube, wherein the portion extends past an opposing side of the support frame relative to said food rod tube
